(19) United States
(12) Patent Application Publication
(10) Pub. No.: US 2022/0166855 A1
(43) Pub. Date: May 26, 2022

(54) SYSTEM FOR DEVELOPMENT INTERFACE AND DATA TRANSMISSION METHOD FOR DEVELOPMENT INTERFACE

(71) Applicant: Generalplus Technology Inc., Hsinchu City (TW)

(72) Inventors: CHENG HSUAN WANG, Hsinchu City (TW); CHUNG HSIN CHEN, Hsinchu City (TW)

(21) Appl. No.: 17/105,145

(22) Filed: Nov. 25, 2020

(51) Int. Cl. H04L 29/06

(52) U.S. Cl. CPC H04L 69/22; H04L 69/08; H04L 69/10; H04L 69/26

(57) ABSTRACT

The invention relates to a system for development interface and a data transmission method for development interface. The system includes a development board and a host computer. The development board is electrically connected to the host computer by a debug interface. The data format transmitted by host computer includes a header field, an address field and a data field. When performing mass data transfer, a specific command is set in the header field to lift the restriction for the length of the data field. When the development board receives the specific command, a serial data transmission mode is switched to receive all data of the data field.

### BACKGROUND OF THE INVENTION

### Field of the Invention

The invention relates to the development interface, and more particularly to a technology for a mass data transmission in a development interface.

### Description of the Related Art

When a product or an integrated circuit is still on the research or design phase, the designer would adopt a development board to program functions to be designed, wherein the data to be written need a debug transmission interface to transmit to the development board. The debug transmission interface generally is a SWD (Serial Wire Debug) interface or JTAG (Joint Test Action Group) interface. Taking the SWD interface as an example, when a mass data transmission is performed, the data rate is only 32/43. FIG. 1 illustrated a transmission data diagram of SWD interface according to prior art. Referring to FIG. 1, the header field includes a startup bit, an address information, an check bit and an ending bit. The header field uses 8 bits, and the ACK field uses 3 bits. Thus, the actual data space is only 32 bits. Therefore, the data rate in SWD interface is not quite satisfactory. If the SWD interface is adopted to perform the mass data transmission, the designer or user may need to spend a long time waiting for data transmission.

### BRIEF SUMMARY OF THE INVENTION

An objective of the invention is to provide a system for development interface and a mass data transmission method for development interface to reduce the data transmission period and also to reduce the development time of integrated circuit or product.

In view of this, the invention provides a system for development interface. The a system for development interface includes a development board and a host PC. The development board includes a debug transmission interface. The host PC is used for being electrically connected to the debug transmission interface. A data form of the debug transmission interface includes a header field, an address field and a data field. The specific instruction is set in the header field when a mass data transmission is performed, such that a length limitation of the data field is removed, wherein a serial data transfer mode is switched when the development board receives the specific instruction, such that all of data in the data field can be received.

The system for development interface according to a preferred embodiment of the present invention, when the data are received in the serial data transfer mode, the development board switches to an original debug transmission mode.

The present invention further provides a system for development interface. The system for development interface includes a development board and a host PC. The development board includes a debug transmission interface. The host PC is used for being electrically connected to the debug transmission interface. The development board includes an in-system programming (ISP) function, wherein, when a host PC transmits a preset data to the development board, the host determines a specific compression encoding from a plurality of compression encodings according to a characteristic of the preset data and the host PC performs a data compression to the preset data to obtain a compressed data according to the specific compression encoding, wherein an ISP firmware and the compressed data are transmitted to the development board, wherein the development board decompresses the compressed data according to the ISP firmware.

The system for development interface according to a preferred embodiment of the present invention, the host PC edits the ISP firmware according to the specific compression encoding. In a preferred embodiment, the host PC divides the preset data into a plurality of sub-segment data and then compresses the plurality of sub-segment data.

The present invention further provides a mass data transmission method for development interface. The mass data transmission method for development interface includes: providing a host PC and a development board; providing a debug transmission interface, wherein a data form of the debug transmission interface comprising a header field, an address field and a data field; setting a specific instruction in the header field to remove a length limitation of the data field when the host PC performs a mass data transmission; and switching to a serial data transfer mode when the development board receives the specific instruction, such that all of data in the data field can be received.

The spirit of the invention is to set a specific instruction in header field of the debug transmission signal such that the limitation of the data length can be removed. Therefore, the data transmission rate of the development interface can be achieved to near 100%, and the data transmission period can be effectively shortened. Moreover, in the embodiment of the present invention, the ISP download method and adaptive compression encoding also are adopted such that the efficiency of the data compression is increased and the data transmission rate is greatly increased.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

FIG. 1 illustrated a transmission data diagram of SWD interface according to prior art.

FIG. 2 illustrates a system block diagram of a development system of an embedded system according to a preferred embodiment of the present invention.

FIG. 3 illustrates a data format diagram according to a preferred embodiment of the present invention.

FIG. 4 illustrates the flowchart depicting a mass data transmission method in the development interface according to a preferred embodiment of the present invention.

FIG. 5 illustrates the flowchart depicting a mass data transmission method in the development interface according to a preferred embodiment of the present invention.

### DETAILED DESCRIPTION OF THE INVENTION

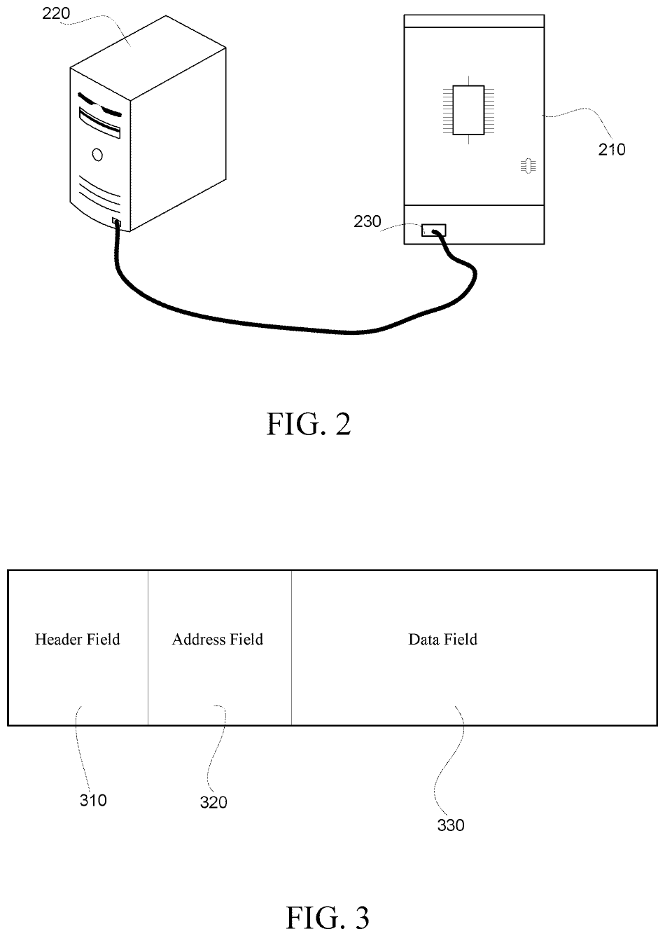

FIG. 2 illustrates a system block diagram of a development system of an embedded system according to a preferred embodiment of the present invention. Referring to FIG. 2, the system for development interface includes a development board 210 and a host PC 220, wherein the development board 210 has a debug transmission interface 230. The development board 210 is electrically connected to the host PC through the debug transmission interface 230.

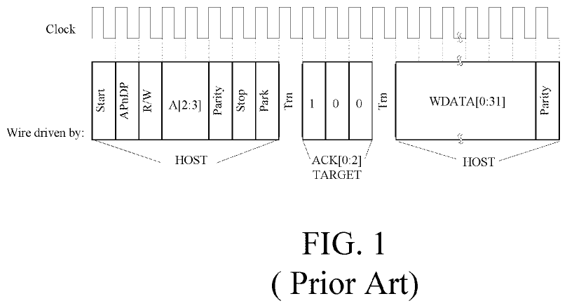

In this embodiment, the development system of the embedded system is adapted for IC (integrated circuit) or product development, such as development phase, circuit research phase or circuit test phase. User need to perform firmware rewriting or transmitting data into the development board 210. Generally, when user want to transmits the data from the host PC 220 to the development board 210, it need to transmit through the debug transmission interface 230 to the development board 210. Generally, the debug transmission interface 230 may be a SWD interface or JTAG interface and so forth. Taking SWD interface as an example, in a general debug transmission mode, since every time the writing is performed, the signal should include header field and confirmation information according to SWD protocol, the data utilization of the SWD protocol is only 32/43, as shown in FIG. 1. When the host PC 220 need to transmit mass data to the development board 210, the data transmission would waste a lot of time when the general debug transmission mode is adopted.

In the preset embodiment, a preset data format is designed. The data format includes a header field 310, an address field 320 and a data field 330. Referring to FIG. 3, FIG. 3 illustrates a data format diagram according to a preferred embodiment of the present invention. The header field 310 is designated a specific instruction for removing the length limitation of the data field. The address field 320 is for designating an address to be written. When the IC of the development board 210 reads the specific instruction, it means the host PC would performs the mass data transmission, in this time, a serial transmission mode is enabled, and the data in the data field 330 would be written according to the information of the address field 320. In serial transmission mode in a preferred embodiment of the present invention, I2C may be adopted for data transmission between the development board 210 and the host PC 220. The data utilization rate may achieve close to 100%. When the data transmission ends, the development board 210 returns to general debug transmission mode.

In addition, when the data transmission in the data field 330 is finished, and a next mass transmission data in the host PC 220 is to be transmitted, the host PC 220 would send the data as form in FIG. 3 again to continuously perform the serial transmission mode. When the host PC 220 switches the serial transmission mode to the general debug transmission mode, the host PC 220 may transmit the end instruction to the development board 210 for example. However, people having ordinary skill in the art should know that the development board 210 may switch to the general debug transmission mode after the data is successfully received. Further the host PC 220 may inform the development board 210 of the length of the data field in advance. The present invention is not limited thereto.

In accordance with the abovementioned embodiment of the present invention, the instruction in header field can be used for switching the transmission mode between the transmitter and receiver, such that the mass data transmission can be achieved in the low speed transmission system.

In another preferred embodiment of the present invention, the development board 210 has an ISP (in-system programming) function, in this embodiment, the ISP function is adopted for optimizing the efficiency of data transmission. Generally speaking, when user needs to write data on the development board 210, because of the limitation of the capacity of the random access memory (RAM) in the development board 210, the preset data to be written in the development board 210 would be compressed by the host PC 220 first by a compression coding. Next, the host PC 220 transmits the compression coding of the IPS firmware and then the compressed data is written in the RAM of the development board 210. The development board 210 de-compresses the compressed data and writes the de-compressed data through the compression coding of the IPS firmware. In the prior art, since the preset compression method is fixed, it cannot efficiently compress data such that the written data period would be too long.

In the preferred embodiment, before the data is written, the host PC 220 would perform a firmware program to analyze the preset data to be written. At the same time, the firmware program can determine the compression encoding according to the characteristic of the preset data, the operation capability of the development board 210 and the type of the IC of the development board 210. In the present embodiment, the compression encoding may be RLE (Run Length Encoding), Huffman coding or GPZP encoding.

In the current application, the preset data to be transmitted by the host PC 220 includes program codes, pictures or videos, etc. For example, when the preset data to be transmitted is a picture, which the data is large and the data variation is small, the RLE can achieve very high compress ratio if the picture data has a lot of black or white portion. In addition, if the preset data to be transmitted is program code, which the data variation is large and the data size is small, it may not be adapted for the RLE, it is adapted for the Huffman coding.

Through the abovementioned analysis, the host PC 220 determines a preset compression encoding, the host PC 220 sets a specific ISP firmware and then compresses the preset data, and transmits the specific ISP firmware and the compressed data to the RAM of the development board 210. Further, in a preferred embodiment of the present invention, considering the size of the preset data and the data capability which the debug interface can be carried in ISP download, the host PC 220 may divide the preset data into multiple segment data and individually compresses the segment data and then performs the data transmission.

In the development board 210, the IC of the development board 210 would perform the received ISP firmware to enable the ISP download, and de-compresses the compressed segment data. Afterward, the IC of the development board 210 would verify the correctness of the de-compressed data. When the verification is complete, the de-compressed data would be written into the IC. The verification method may be the ISP flow, or the embedded algorithm in IC, such as CRC (Cyclical Redundancy Check).

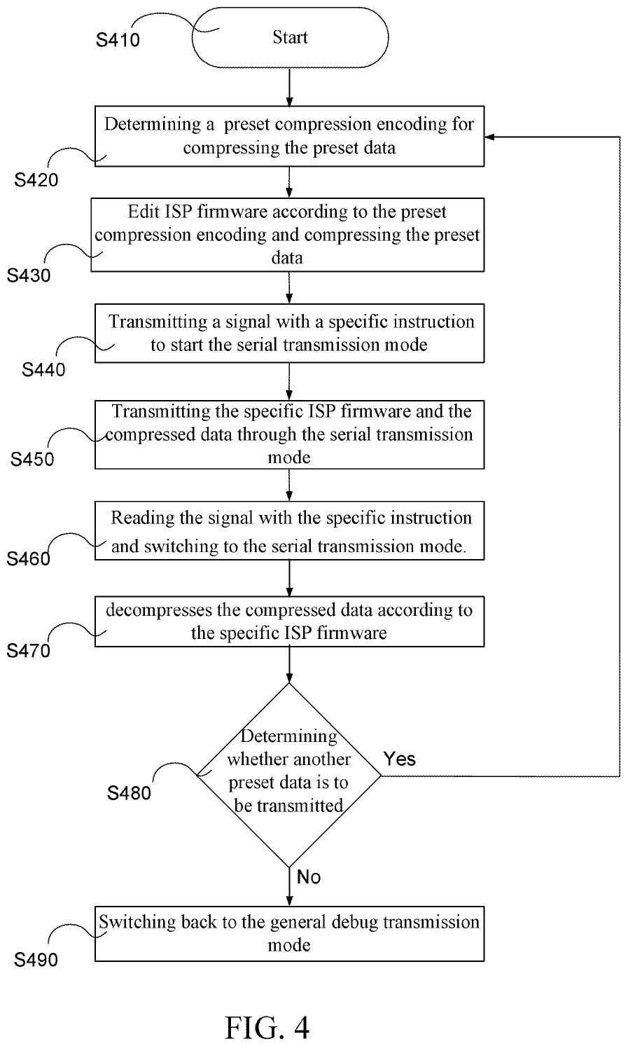

According to the abovementioned embodiment, the mass data transmission method can be concluded. FIG. 4 illustrates the flowchart depicting a mass data transmission method in the development interface according to a preferred embodiment of the present invention. Referring to FIG. 4, the method includes the steps as follow.

In step S410, the method starts when the host PC 220 has a preset data to be written into the IC of the development board 210.

In step S420, a preset compression encoding is determined for compressing the preset data.

In step S430, the ISP firmware is edited according to the preset compression encoding and the preset data is compressed by the host PC 220 to obtain a compressed data.

In step S440, the host PC 220 transmits a signal with a specific instruction to start the serial transmission mode.

In step S450, the host PC 220 starts to transmit the specific ISP firmware and the compressed data through the serial transmission mode.

In step S460, the IC of the development board 210 reads the signal with the specific instruction and switches to the serial transmission mode.

In step S470, the development board 210 receives the specific ISP firmware and decompresses the compressed data and verifies it.

In step S480, it is determined whether another preset data is to be transmitted to the development board 210. If the determination is positive, return to step S420. In step S480, after the transmission ends, if the host PC 220 still has next data to be transmitted to the development board 210, the program in the host PC 220 would re-determine the compression encoding and generate new ISP firmware. If the determination is negative, go to step S490.

In step S490, the transmission ends, the development board 210 is switched to the general debug transmission mode.

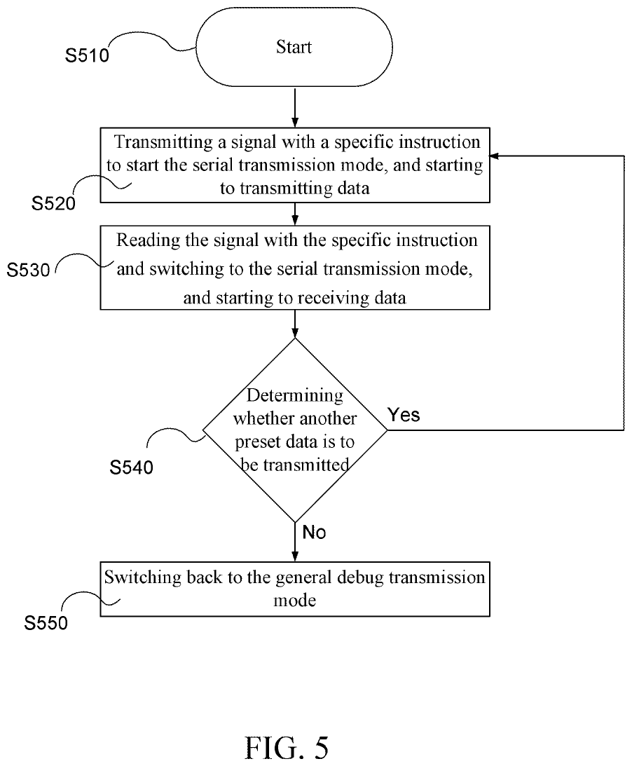

In the embodiment of FIG. 4, if the data is not compressed, the flowchart can be simplified as FIG. 5. FIG. 5 illustrates the flowchart depicting a mass data transmission method in the development interface according to a preferred embodiment of the present invention. Referring to FIG. 5.

In step S510, the method starts when the host PC 220 has a preset data to be written into the IC of the development board 210.

In step S520, the host PC 220 transmits a signal with a specific instruction to start the serial transmission mode and transmits the preset data.

In step S530, the IC of the development board 210 reads the signal with the specific instruction, the development board 210 is switched to the serial transmission mode and receives the preset data.

In step S540, it is determined whether another preset data is to be transmitted to the development board 210. If the determination is positive, return to step S520. If the determination is negative, perform the step S550.

In step S550, the transmission ends, the development board 210 is switched to the general debug transmission mode.

In summary, the spirit of the invention is to set a specific instruction in header field of the debug transmission signal such that the limitation of the data length can be removed. Therefore, the data transmission rate of the development interface can be achieved to near 100%, and the data transmission period can be effectively shortened. Moreover, in the embodiment of the present invention, the ISP download method and adaptive compression encoding also are adopted such that the efficiency of the data compression is increased and the data transmission rate is greatly increased.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A system for development interface, comprising:
a development board, comprising a debug transmission interface;
a host PC, used for being electrically connected to the debug transmission interface;
wherein a data form of the debug transmission interface comprising a header field, an address field and a data field,
wherein a specific instruction is set in the header field when a mass data transmission is performed, such that a length limitation of the data field is removed,
wherein a serial data transfer mode is switched when the development board receives the specific instruction, such that all of data in the data field can be received.

2. The system for development interface according to claim 1, wherein, when the data are received in the serial data transfer mode, the development board switches to an original debug transmission mode.

3. The system for development interface according to claim 1, wherein the debug transmission interface is SWD interface (Serial Wired Debug Interface).

4. The system for development interface according to claim 1, wherein the debug transmission interface is JTAG (Joint Test Action Group) interface.

5. The system for development interface according to claim 1, wherein the host PC comprises a USB (Universal Serial Bus) interface, wherein the host PC is electrically connected to the debug transmission interface through the USB interface and an adapter circuit.

6. A system for development interface, comprising:
a development board, comprising a debug transmission interface;
a host PC, used for being electrically connected to the debug transmission interface;
wherein the development board includes an in-system programming (ISP) function,
wherein, when a host PC transmits a preset data to the development board, the host determines a specific compression encoding from a plurality of compression encodings according to a characteristic of the preset data and the host PC performs a data compression to the preset data to obtain a compressed data according to the specific compression encoding,
wherein an ISP firmware and the compressed data are transmitted to the development board,
wherein the development board decompresses the compressed data according to the ISP firmware.

7. The system for development interface according to claim 6, wherein the host PC edits the ISP firmware according to the specific compression encoding.

8. The system for development interface according to claim 6, wherein the host PC divides the preset data into a plurality of sub-segment data and then compresses the plurality of sub-segment data.

9. The system for development interface according to claim 6, wherein after the development board de-compressed the compressed data, performs the ISP firmware to verify the correctness of a decompressed data.

10. The system for development interface according to claim 6, wherein after the development board de-compressed the compressed data, the development board verifies the correctness of a decompress data according to the CRC (Cyclical Redundancy Check)

11. The system for development interface according to claim 6, wherein the debug transmission interface is SWD interface (Serial Wired Debug Interface).

12. A mass data transmission method for development interface, comprising:
providing a host PC and a development board;
providing a debug transmission interface, wherein a data form of the debug transmission interface comprising a header field, an address field and a data field;
setting a specific instruction in the header field to remove a length limitation of the data field when the host PC performs a mass data transmission; and
switching to a serial data transfer mode when the development board receives the specific instruction, such that all of data in the data field can be received.

13. The mass data transmission method for development interface according to claim 12, wherein after receiving all of data in the data field in the serial data transfer mode, further comprising:
switching to an original debug transmission mode by the development board.

14. The mass data transmission method for development interface according to claim 12, wherein the development board comprises a ISP (In-System Programming) function,
wherein, when the host PC transmits a preset data to the development board, the method further comprises:
determining a specific compression encoding from a plurality of compression encodings according to a characteristic of the preset data, and compressing the preset data into a compressed data according to the specific compression encoding;
transmitting a ISP firmware and the compressed data to the development board from the host PC; and
decompressing the compressed data by the development board according to the ISP firmware.

15. The mass data transmission method for development interface according to claim 14, wherein the host PC edits the ISP firmware according to the specific compression encoding.

16. The mass data transmission method for development interface according to claim 14, wherein, when the host PC transmits the preset data to the development board, dividing the preset data into a plurality sub-segment data and then compressing the plurality of sub-segment data.

17. The mass data transmission method for development interface according to claim 14, wherein after the development board de-compressed the compressed data, performing the ISP firmware to verify the correctness of a decompressed data.

18. The mass data transmission method for development interface according to claim 14, wherein after the development board de-compressed the compressed data, verifying the correctness of a decompress data according to the CRC (Cyclical Redundancy Check)
